(19) United States
(12) Patent Application Publication
(10) Pub. No.: US 2015/0106229 A1
(43) Pub. Date: Apr. 16, 2015

(54) LOCAL BUYER AND SELLER CONNECTION PLATFORM

(71) Applicant: Nate Lyman, Livermore, CA (US)

(72) Inventor: Nate Lyman, Livermore, CA (US)

(21) Appl. No.: 14/051,919

(22) Filed: Oct. 11, 2013

(51) Int. Cl. G06Q 30/06

(52) U.S. Cl. CPC G06Q 30/0639
USPC 705/26.9

(57) ABSTRACT

A system and method for a local buyer and seller connection platform are described. An item listed by a seller of an online marketplace is compared with a list of desired items identified by a buyer. A determination of whether a geographic location of the seller is within a buyer geofence and whether a geographic location of the buyer is within a seller geofence is performed. The buyer is provided with an option to purchase the item and pick up the item from the seller when the item listed by the seller matches a desired item identified by the buyer and when the geographic location of the seller is within the buyer geofence and the geographic location of the buyer is within the seller geofence. Geographic boundary parameters for the seller geofence and the buyer geofence are stored in a storage device.

### TECHNICAL FIELD

This application relates generally to the field of computer technology and, in a specific example embodiment, to a method and system for connecting local buyers and sellers of an online marketplace.

### BACKGROUND

Online marketplaces include many sellers listing items for sale. Buyers buy these items and sellers ship the items to the buyer upon receipt of payment. The shipping process typically includes the seller packing the item in a box, sealing it up, bringing it to the post office, filling out the specified forms, weighing it to calculate the postage, paying for the postage, affixing the stamp on the box, and finally dropping the box in the parcel deposit area. Because this inefficient shipping process entails many steps, it becomes a deterrent for sellers to list, sell, and ship their items.

### BRIEF DESCRIPTION OF THE DRAWINGS

The present disclosure is illustrated by way of example, and not by way of limitation, in the figures of the accompanying drawings in which:

FIG. 1 is a network diagram depicting a network system having a client-server architecture configured for exchanging data over a network, according to one embodiment.

FIG. 2 shows a block diagram illustrating one example embodiment of a marketplace application.

FIG. 3 shows a block diagram illustrating one example embodiment of a local buyer and seller connection application.

FIG. 4 shows a flow diagram illustrating one example embodiment of a method for operating a local buyer and seller connection application.

FIG. 5 shows a block diagram illustrating one example of buyer and seller geofences.

FIG. 6 shows a block diagram illustrating one example embodiment of an operation of a local buyer and seller connection application.

FIG. 7 shows a ladder diagram illustrating one example embodiment of an operation of a local buyer and seller connection application.

FIG. 8 shows a diagrammatic representation of machine, in the example form of a computer system, within which a set of instructions may be executed to cause the machine to perform any one or more of the methodologies discussed herein.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for a local buyer and seller connection platform are described. An item listed by a seller of an online marketplace is compared with a list of desired items identified by a buyer. A determination of whether a geographic location of the seller is within a buyer geofence and whether a geographic location of the buyer is within a seller geofence is performed. The buyer is provided with an option to purchase the item and pick up the item from the seller when the item listed by the seller matches a desired item identified by the buyer and when the geographic location of the seller is within the buyer geofence and the geographic location of the buyer is within the seller geofence. Geographic boundary parameters for the seller geofence and the buyer geofence are stored in a storage device.

In one embodiment, the geographic location (e.g., GPS data) of a mobile device of the seller and the geographic location (e.g., GPS data) of a mobile device of the buyer are determined. The system then determines whether the geographic location of the mobile device of the seller is within the buyer geofence and whether the geographic location of the mobile device of the buyer is within the seller geofence.

### System Architecture

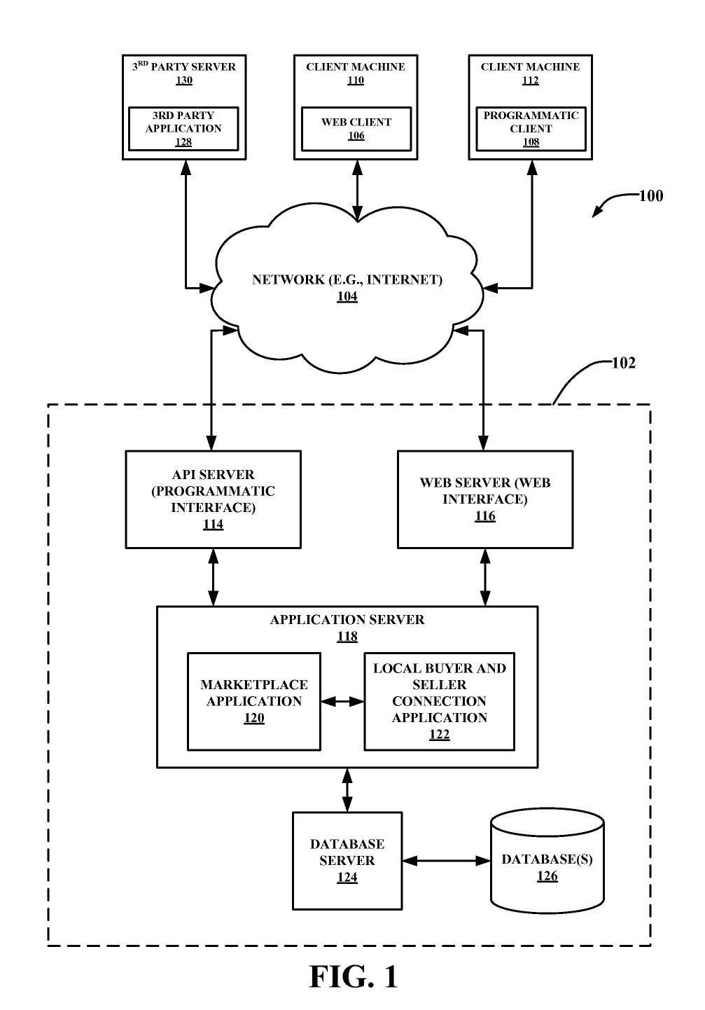

FIG. 1 is a network diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture, other embodiments may include other network architectures, such as peer-to-peer or distributed network environments.

A data exchange platform, in an example form of a marketplace application 120 and a local buyer and seller connection application 122, may provide server-side functionality, via a network 104 (e.g., the Internet) to one or more clients. The one or more clients may include users that utilize the network system 100 and, more specifically, the marketplace application 120 and the local buyer and seller connection application 122, to exchange data over the network 104. These transactions may include transmitting, receiving (communicating), and processing data to, from, and regarding content and users of the network system 100. The data may include, but is not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data, such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, each in communication with the networked system 102 and optionally each other. The buyers and sellers may be any one of individuals, merchants, or service providers.

Turning specifically to the marketplace application 120 and the local buyer and seller connection application 122, an application program interface (API) server 114 and a web server 116 are coupled to, and provide programmatic and web interfaces respectively to, one or more application servers 118. The application server 118 hosts one or more marketplace applications 120 and one or more local buyer and seller connection applications 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods and/or services (e.g., for sale) published on the marketplace application 120.

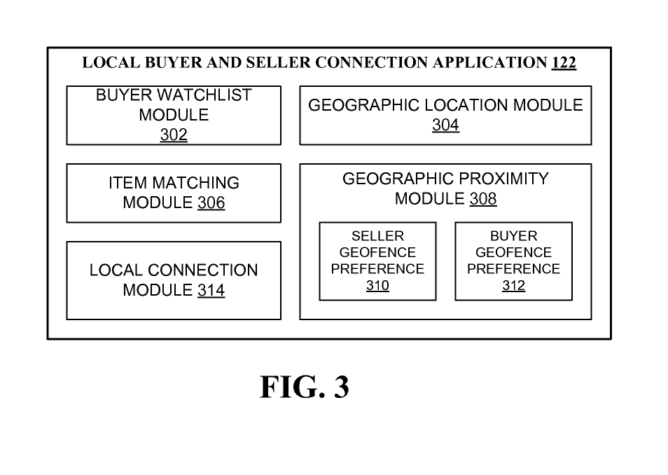

In one embodiment, the local buyer and seller connection application 122 includes a system and a method for identifying an available item for sale by a seller local to a buyer where the available item has been identified on a watchlist of the buyer. For example, if the item sold by a seller matches items from the watchlist of the buyer and the seller's location is within a geofence specified by the buyer and the buyer's location is within a geofence specified by the seller, the local buyer and seller connection application 122 may offer the buyer the option to purchase from the seller and pick up the item from the local seller. In another example, the local seller may deliver the item to the buyer. The local buyer and seller connection application 122 is described in more detail below with respect to FIG. 3.

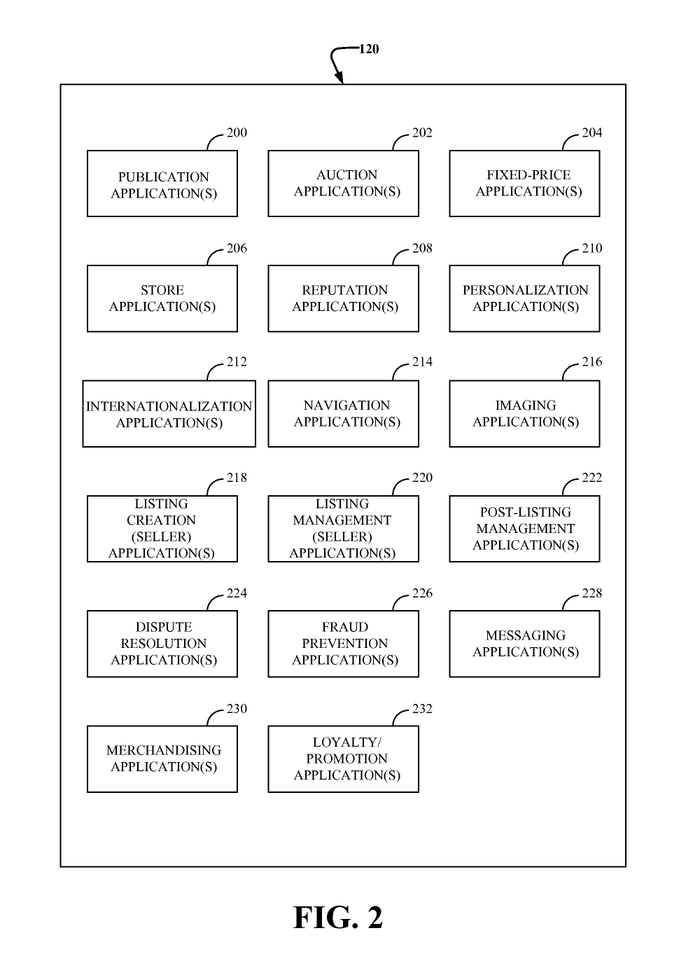

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the local buyer and seller connection application 122 themselves are communicatively coupled (e.g., via appropriate interfaces) to each other and to various data sources, so as to allow information to be passed between the marketplace application 120 and the local buyer and seller connection application 122 or so as to allow the marketplace application 120 and the local buyer and seller connection application 122 to share and access common data. The marketplace application 120 and the local buyer and seller connection application 122 may, furthermore, access one or more databases 126 via the database servers 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace application 120 may include one or more imaging applications 216, which users may utilize to upload images for inclusion within the listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the local buyer and seller connection application 122. The local buyer and seller connection application 122 may include a buyer watchlist module 302, a geographic location module 304, an item matching module 306, a geographic proximity module 308, and a local connection module 314.

The buyer watchlist module 302 receives a selection of items wanted by the buyer and generates a list of desired items based on the selection of items. The watchlist may be different from the shopping cart where the buyer actually finds an available item from a seller and is ready to proceed with a checkout process. The watchlist may identify items that the buyer is interested in purchasing from any seller on the online marketplace. For example, the watchlist of a buyer may include item A (brand x1, model y1), item B (brand x2, model y2). As such, the buyer may be able to monitor the price of the identified items from the watchlist for sale in the online marketplace. In another example, the buyer may place an item in a watchlist because the item is not available in the online marketplace or the item available from available sellers may be too expensive.

The geographic location module 304 determines the geographic location of the seller and the buyer. For example, the geographic location module 304 may use the residence address of the buyer and the business address of the seller. In another embodiment, the geographic location module 304 may determine the geographic location of a mobile device associated with the seller using GPS data from the mobile device of the seller and the geographic location of a mobile device associated with the buyer using GPS data from the buyer. In another embodiment, the geographic location module 304 requests geographic location data from the mobile devices of the buyer and seller on a periodic basis. In another embodiment, the geographic location module 304 may dynamically access geographic location data from the mobile devices of the buyer and seller. In another example, the geographic location module 304 may identify the business address of the seller and the residence address of the buyer.

The item matching module 306 may determine whether an item listed by a seller of the online marketplace is included in the watchlist of a buyer of the online marketplace. For example, the item matching module 306 may determine that item x listed by a seller matches an item that is being sought by the buyer using the watchlist of the buyer.

The geographic proximity module 308 may store geographic boundary parameters for the seller geofence in seller geofence preference 310 and the buyer geofence in buyer geofence preference 312. For example, the geographic boundary parameters may identify the boundaries of geographic areas that the seller or buyer is willing to travel. For example, the seller may identify geographic boundaries of a town of the seller. In other words, the seller identifies how far the seller is willing to travel to meet with a buyer, or to deliver the item. Similarly, the buyer may identify geographic boundaries of a neighborhood of the buyer. In other words, the buyer identifies how far the buyer is willing to travel to pick up an item from the seller. The geographic boundary parameters may include neighbor, town, cities, school campus, or any user-defined geographic boundaries.

In another example, the geographic boundaries may be identified using a user-defined (e.g., seller or buyer) radius with the location of the respective mobile devices as center. In another example, the geographic boundaries may be identified using a user-defined (e.g., seller or buyer) radius with the location of the business address or warehouse of the seller, and the residence address or work address of the buyer.

The local connection module 314 determines whether a geographic location of the seller is within the buyer geofence and whether a geographic location of the buyer is within the seller geofence. For example, if the local connection module 314 determines that the item listed by the seller matches a desired item identified by the buyer, that the geographic location of the seller is within the buyer geofence, and that the geographic location of the buyer is within the seller geofence, the local connection module 314 may provide the buyer with an option to purchase the item from the local seller and pick up the item from the local seller.

In one embodiment, the local connection module 314 determines whether the geographic location of the mobile device of the seller is within the buyer geofence and whether the geographic location of the mobile device of the buyer is within the seller geofence. For example, if the seller is traveling to a geographic area within the buyer geofence, and the seller has the item desired by the buyer with him, the local connection module 314 may trigger a notification to the seller and buyer to suggest the local transaction. In another embodiment, the local connection module 314 may first ask if the seller is willing to deliver the item local to the location of the seller since the local connection module 314 may already determine that the seller is traveling by using the GPS data from the mobile device of the seller. If the seller is willing to deliver the item locally, the local connection module 314 may provide the option to the buyer to purchase the item from the local seller. The local connection module 314 may then provide information on where to meet the buyer to pick up the item or may offer the option for the seller to deliver the item to the buyer.

In one embodiment, the marketplace application 120 generates a financial transaction between the seller and the buyer upon receiving confirmation from the buyer that the item has been received. Funds may be received from the buyer and transferred to the seller upon confirmation of the item being received by the buyer. In another example, the financial transaction may take into account whether the item has been picked up by the buyer or whether the item has been delivered by the seller. In other words, the buyer may pay an extra fee to have the seller deliver the item at the location of the buyer or a location associated with the buyer.

In another embodiment, the marketplace application 120 generates a financial transaction automatically between the seller and the buyer upon receiving confirmation from the local buyer and seller connection application 122 that the parameters are met (e.g., an item listed by a seller matching the watchlist of the buyer and location of the buyer and seller within the geographic geofence preferences). That way, for example, a buyer could set up the watch list as more than just a watch list where the buyer gets an alert when a product is available, but where the marketplace application 120 actually just goes ahead and initiates buying the item on behalf of the user. This may be useful for rare/high demand items where a user is concerned that the item may sell so quickly they don't have time to respond.

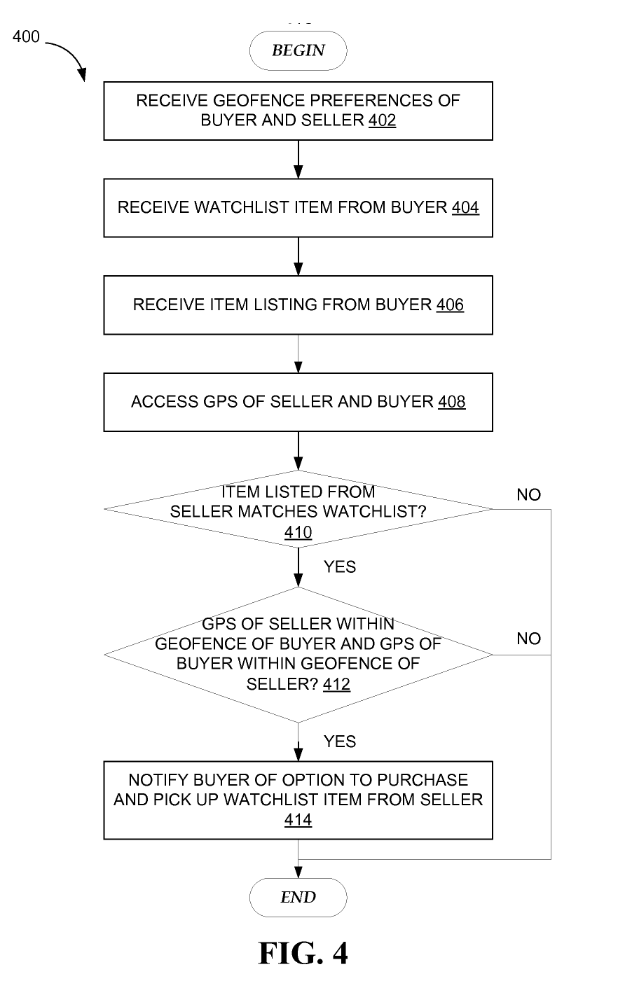

FIG. 4 shows a flow diagram illustrating one example embodiment of a method 400 for operating a local buyer and seller connection application. At operation 402, geofence preferences of the buyer and seller are received. The geofence preferences of the buyer and seller may be stored in the geographic proximity module 308. In particular, the geographic parameters for the seller may be stored in the seller geofence preference 310. The geographic parameters for the buyer may be stored in the buyer geofence preference 312.

At operation 404, a watchlist associated with the buyer is accessed. For example, the buyer watchlist module 302 may generate the watchlist for the buyer. The watchlist may include a list of items wanted by the buyer.

At operation 406, an item listing is generated in response to a seller listing an item for sale on the online marketplace. For example, the marketplace application 120 may be used to generate the item listing.

At operation 408, the geographic locations of the seller and buyer are determined. For example, the GPS data from a mobile device of the seller and the buyer may be accessed to determine their respective geographic locations.

At operation 410, the item matching module 306 determines whether the item listed by the seller corresponds or matches an item included in the watchlist of the buyer.

At operation 412, the local connection module 314 determines whether the geographic location of the seller is within the geofence of the buyer and the geographic location of the buyer is within the geofence of the seller. In one example, the geographic location may include the dynamic geographic location of the mobile device of the seller or buyer. In another example, the geographic location may include the geographic location of a static address of the seller or the buyer (e.g., residence address, work address).

At operation 414, if the item listed by the seller corresponds or matches an item included in the watchlist of the buyer and the geographic location of the seller is within the geofence of the buyer and the geographic location of the buyer is within the geofence of the seller, the local connection module 314 generates a notification to the buyer to provide the buyer with an option to purchase and pick up the item from the local seller. In another example, the local connection module 314 generates a notification to the seller with an option to deliver the item to the local buyer.

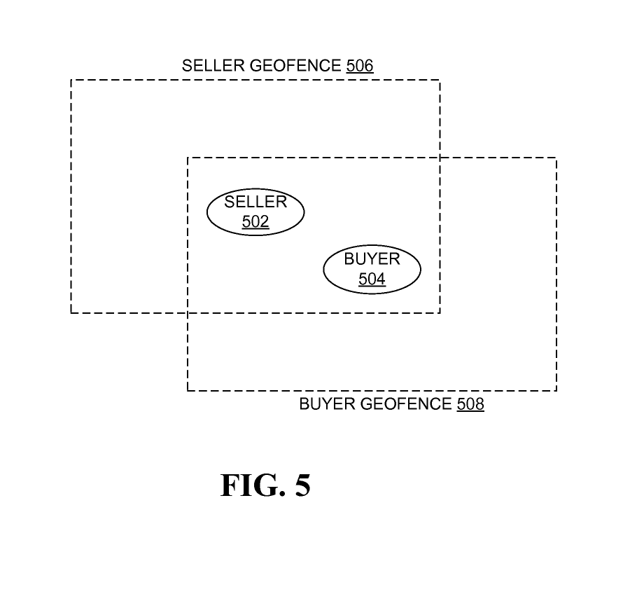

FIG. 5 shows a block diagram illustrating one example of buyer and seller geofences. A seller 502 has a corresponding seller geofence 506. A buyer 504 has a corresponding buyer geofence 508. In one embodiment, the geographic proximity module 308 determines whether the geographic location of the seller 502 is within the boundaries of the buyer geofence 508 and whether the geographic location of the buyer 504 is within the boundaries of the seller geofence 506. FIG. 5 illustrates an example where the geographic location of the seller 502 is within the boundaries of the buyer geofence 508 and where the geographic location of the buyer 504 is within the boundaries of the seller geofence 506.

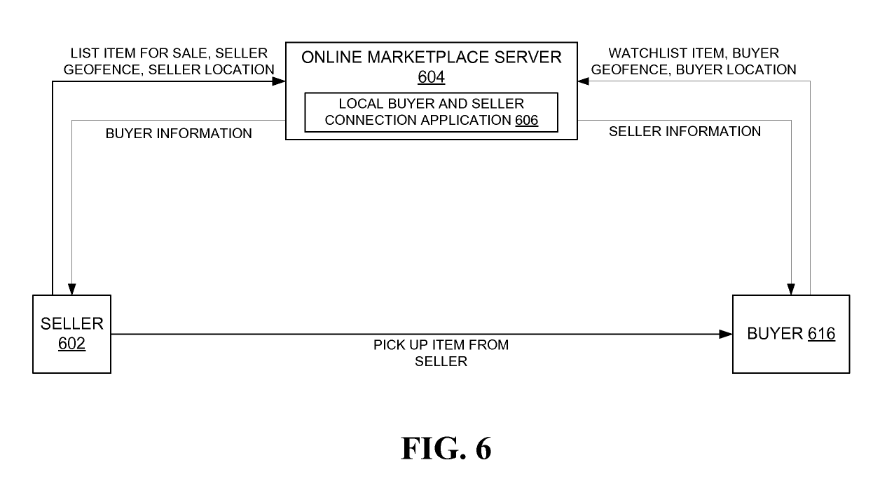

FIG. 6 shows a block diagram illustrating one example embodiment of an operation of a local buyer and seller connection application. The online marketplace server 604 may include a local buyer and seller connection application 606. A seller 602 may list an item for sale with the online marketplace server 604. The seller 602 may provide item information, seller geofence information, and seller location information. The buyer 616 may provide the online marketplace server 604 with a watchlist of items wanted by the buyer 616. In addition, the buyer 616 may provide buyer geofence information and buyer location information.

The local buyer and seller connection application 606 may determine whether the item listed by the seller 602 matches the watchlist of the buyer 616 and whether the seller 602 is local to the buyer 616 based on their respective geographic location and geofence information. The local buyer and seller connection application 606 may then provide buyer information to the seller 602 and seller information to the buyer 616 so that the buyer 616 may arrange and pick up the item directly from the seller 602. The online marketplace server 604 maintains the financial transaction between the seller 602 and the buyer 616. In other words, no money is exchanged in person when the buyer 616 picks up the item from the seller 602. The financial transaction is handled electronically by the online marketplace server 604.

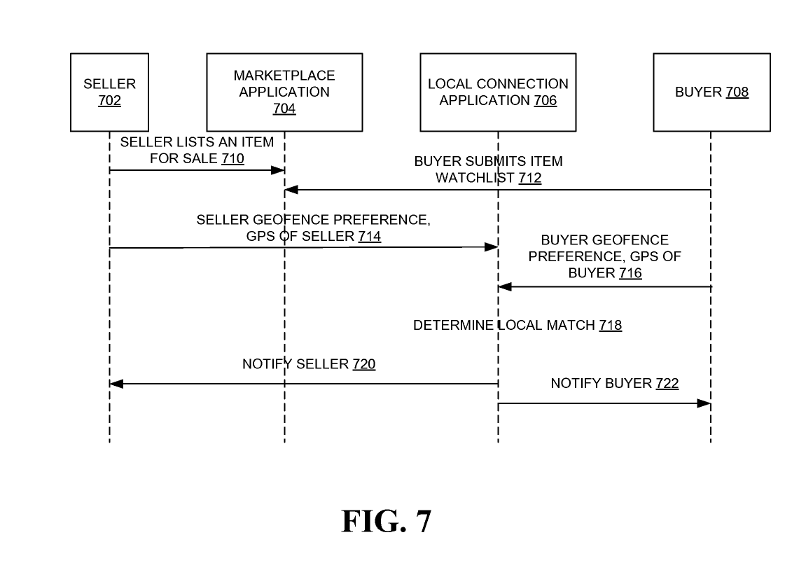

FIG. 7 shows a ladder diagram illustrating one example embodiment of an operation of a local buyer and seller connection application. At operation 710, a seller 702 lists an item for sale in the marketplace application 704. At operation 712, a buyer 708 selects items for a watchlist and submits the watchlist to the marketplace application 704. At operation 714, the seller geofence preferences and the GPS location of a mobile device (e.g., smartphone) of the seller 702 are provided to the local connection application 706. At operation 716, the buyer geofence preferences and the GPS location of a mobile device (e.g., smartphone) of the buyer 708 are provided to the local connection application 706. At operation 718, the local connection application 706 determines whether the item listed by the seller 702 matches the watchlist of the buyer 708 and whether the seller 702 is in proximity to the buyer 708 based on their GPS location and geofence preferences. If the previous two conditions are satisfied, the local connection application 706 generates a notification to the seller at operation 720 and a notification to the buyer at operation 722.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below, are set out hardware (e.g., machine) and software architectures that may be deployed in various example embodiments.

### Example Computer System

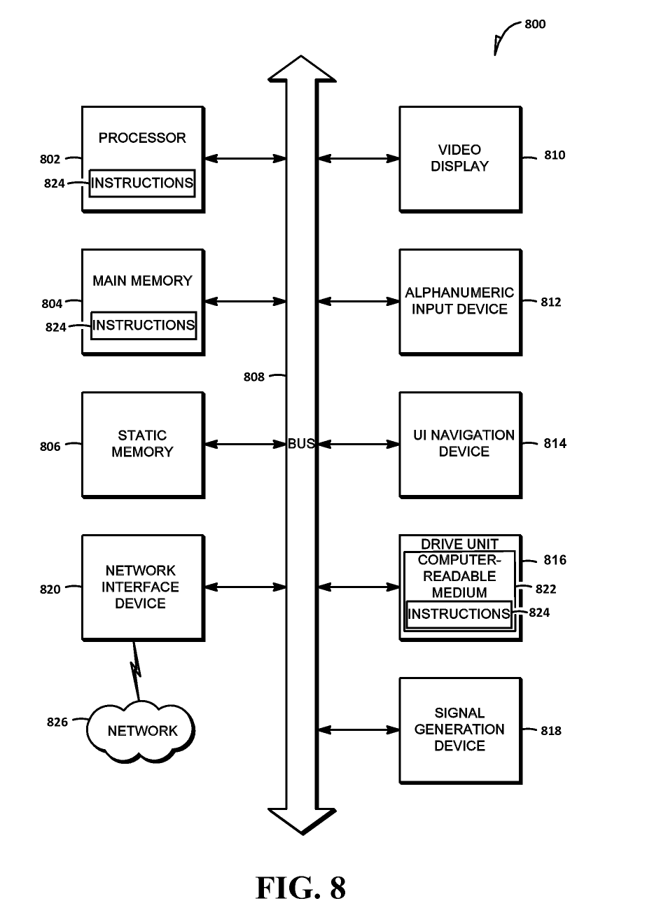

FIG. 8 shows a diagrammatic representation of a machine in the example form of a computer system 800 within which a set of instructions 824 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 824 (sequential or otherwise) that specify actions to be taken by that machine. Further, while only a single machine is illustrated, the term “machine” shall also be taken to include any collection of machines that individually or jointly execute a set (or multiple sets) of instructions 824 to perform any one or more of the methodologies discussed herein.

The example computer system 800 includes a processor 802 (e.g., a central processing unit (CPU), a graphics processing unit (GPU, or both)), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a UI navigation device 814 (e.g., a mouse), a disk drive unit 816, a signal generation device 818 (e.g., a speaker), and a network interface device 820.

The disk drive unit 816 includes a computer-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting machine-readable media.

The instructions 824 may further be transmitted or received over a network 826 via the network interface device 820 utilizing any one of a number of well-known transfer protocols (e.g., HTTP).

While the computer-readable medium 822 is shown in an example embodiment to be a single medium, the term “computer-readable medium” should be taken to include a single medium or multiple media (e.g., a centralized or distributed database, and/or associated caches and servers) that store the one or more sets of instructions 824. The term “computer-readable medium” shall also be taken to include any medium that is capable of storing, encoding, or carrying a set of instructions 824 for execution by the machine and that cause the machine to perform any one or more of the methodologies of the present disclosure, or that is capable of storing, encoding or carrying data structures utilized by or associated with such a set of instructions 824. The term “computer-readable medium” shall, accordingly, be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
an item matching module executable by a processor configured to determine whether an item listed by a seller of an online marketplace is included in a list of desired items identified by a buyer of the online marketplace;
a local connection module configured to determine whether a geographic location of the seller is within a buyer geofence and whether a geographic location of the buyer is within a seller geofence, and to provide the buyer with an option to purchase the item from the seller and pick up the item from the seller when the item listed by the seller matches a desired item identified by the buyer and when the geographic location of the seller is within the buyer geofence and the geographic location of the buyer is within the seller geofence; and
a storage device comprising geographic boundary parameters for the seller geofence and the buyer geofence.

2. The system of claim 1, further comprising:
a geographic proximity module configured to determine the geographic boundary parameters for the seller geofence and the buyer geofence, the geographic boundary parameters for the seller geofence identifying a first geographic boundary preference specified by the seller, the parameters for the buyer geofence identifying a second geographic boundary preference specified by the buyer.

3. The system of claim 1, further comprising:
a geographic location module configured to determine the geographic location of a mobile device of the seller and the geographic location of a mobile device of the buyer,
wherein the local connection module is configured to determine whether the geographic location of the mobile device of the seller is within the buyer geofence and whether the geographic location of the mobile device of the buyer is within the seller geofence.

4. The system of claim 3, wherein the geographic location module determines the geographic location of the mobile device of the seller based on Global Positioning System (GPS) information received from the mobile device of the seller, and the geographic location of the mobile device of the buyer based on Global Positioning System (GPS) information received from the mobile device of the buyer.

5. The system of claim 1, further comprising:
a buyer watchlist module configured to receive a selection of items wanted by the buyer and to generate the list of desired items based on the selection of items.

6. The system of claim 1, wherein the location connection module is configured to receive a request from the buyer to purchase the item and to pick up the item from the seller, and to provide information of the buyer to the seller and information of the seller to the buyer.

7. The system of claim 1, wherein the location connection module is configured to receive a request from the buyer to purchase the item and to have the item delivered to the buyer, and to provide information of the buyer to the seller and information of the seller to the buyer.

8. The system of claim 1, wherein the location connection module is configured to provide the geographic location of the seller to the buyer.

9. The system of claim 1, wherein the online marketplace is configured to generate a financial transaction between the seller and the buyer upon receiving confirmation from the buyer that the item has been received.

10. The system of claim 1, wherein the geographic location of the seller comprises a geographic location of the item.

11. A method comprising:
determining, using a processor of a machine, whether an item listed by a seller of an online marketplace is included in a list of desired items identified by a buyer;
determining whether a geographic location of the seller is within a buyer geofence and whether a geographic location of the buyer is within a seller geofence;
providing the buyer with an option to purchase the item and pick up the item from the seller when the item listed by the seller matches a desired item identified by the buyer and when the geographic location of the seller is within the buyer geofence and the geographic location of the buyer is within the seller geofence; and
storing geographic boundary parameters for the seller geofence and the buyer geofence in a storage device.

12. The method of claim 11, further comprising:
determining the geographic boundary parameters for the seller geofence and the buyer geofence, the parameters for the seller geofence identifying a first geographic boundary preference specified by the seller, the geographic boundary parameters for the buyer geofence identifying a second geographic boundary preference specified by the buyer.

13. The method of claim 11, further comprising:
determining the geographic location of a mobile device of the seller and the geographic location of a mobile device of the buyer; and
determining whether the geographic location of the mobile device of the seller is within the buyer geofence and whether the geographic location of the mobile device of the buyer is within the seller geofence.

14. The method of claim 11, further comprising:
determining the geographic location of the mobile device of the seller based on Global Positioning System (GPS) information received from the mobile device of the seller, and the geographic location of the mobile device of the buyer based on Global Positioning System (GPS) information received from the mobile device of the buyer.

15. The method of claim 11, further comprising:
receiving a selection of items wanted by the buyer; and
generating the list of desired items based on the selection of items.

16. The method of claim 11, further comprising:
receiving a request from the buyer to purchase the item and to pick up the item from the seller; and
providing information of the buyer to the seller and information of the seller to the buyer.

17. The method of claim 11, further comprising:
receiving a request from the buyer to purchase the item and to have the item delivered to the buyer; and
providing information of the buyer to the seller and information of the seller to the buyer.

18. The method of claim 11, further comprising:
providing the geographic location of the seller to the buyer.

19. The method of claim 11, further comprising:
generating a financial transaction between the seller and the buyer upon receiving confirmation from the buyer that the item has been received.

20. A non-transitory computer-readable storage medium storing a set of instructions that, when executed by a processor, cause the processor to perform operations, comprising:
determining whether an item listed by a seller of an online marketplace is included in a list of desired items identified by a buyer;
determining whether a geographic location of the seller is within a buyer geofence and whether a geographic location of the buyer is within a seller geofence;
providing the buyer with an option to purchase the item and pick up the item from the seller when the item listed by the seller matches a desired item identified by the buyer and when the geographic location of the seller is within the buyer geofence and the geographic location of the buyer is within the seller geofence; and
storing parameters for the seller geofence and the buyer geofence in a storage device.
